(19) United States
(12) Patent Application Publication
(10) Pub. No.: US 2024/0394097 A1
(43) Pub. Date: Nov. 28, 2024

(54) ONLINE INCREMENTAL SCALING OF A COMPUTE CLUSTER

(71) Applicant: Microsoft Technology Licensing, LLC, Redmond, WA (US)

(72) Inventors: Sumeet Priyadarshee DASH, Lake Forest, CA (US); Jose Aguilar SABORIT, Bellevue, WA (US); Krishnan SRINIVASAN, Sammamish, WA (US); Wei WANG, Madison, WI (US); Miroslaw Adam FLASZA, Laguna Niguel, CA (US); Raghunath RAMAKRISHNAN, Bellevue, WA (US)

(21) Appl. No.: 18/475,017

(22) Filed: Sep. 26, 2023

Related U.S. Application Data
(60) Provisional application No. 63/503,547, filed on May 22, 2023.

(51) Int. Cl. G06F 9/48

(52) U.S. Cl. CPC G06F 9/4881

(57) ABSTRACT

System, methods, apparatuses, and computer program products are disclosed for online incremental autoscaling of a compute cluster. A workload graph is analyzed to determine a resource demand that maximizes concurrency for tasks schedulable on the cluster. An ideal size of the cluster is determined based on the resource demand. A target size of the cluster is determined based on the ideal size of the cluster. When the current size of the cluster is greater than the target size, at least one node of the cluster is designated for downscaling. New tasks are scheduled on nodes of the cluster that are not designated for downscaling. As existing tasks on the node(s) designated for downscaling complete execution, the node(s) designated for downscaling are removed from the cluster.

### CROSS-REFERENCE TO RELATED APPLICATIONS

This application claims priority to U.S. Provisional Patent Application Ser. No. 63/503,547, filed May 22, 2023, and titled “ONLINE INCREMENTAL SCALING OF A COMPUTE CLUSTER,” the entirety of which is incorporated by reference herein.

### BACKGROUND

Cloud-native Data Warehousing and Big Data Analytics services use compute clusters to process multi-query workloads in parallel manner where each query in the workload is scheduled on one or more compute nodes based on its resource demand. Cluster autoscaling is a feature in cloud computing environments that allows the automatic adjustment of the number of instances or nodes within a compute cluster based on the current demand or workload. The primary goal of cluster autoscaling is to optimize resource allocation and minimize costs by scaling the cluster's capacity in real-time according to the workload fluctuations. Instead of manually adding or removing nodes, the cluster autoscaler automates this process.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

System, methods, apparatuses, and computer program products are disclosed for online incremental autoscaling of a compute cluster. A workload graph is analyzed to determine a resource demand that satisfies a concurrency requirement of tasks schedulable on a first subset of the cluster. An ideal cluster size is determined to satisfy the first resource demand. A target size is determined for the first subset based on the ideal cluster size. When a current size of the first subset is determined to be less than the target size, one or more new nodes are added to the first subset of the cluster, and new tasks are scheduled on one or more nodes of the first subset, the one or more nodes including the newly added nodes. When a current size of the first subset is determined to be greater than the target size, one or more nodes of the first subset are designated for downscaling, and new tasks are scheduled on nodes of the first subset that are not designated for downscaling. The nodes designated for downscaling are removed from the cluster as tasks executing on the designated node(s) complete execution.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of an example system for performing online incremental scaling of a compute cluster, in accordance with an embodiment.

FIG. 2 shows a block diagram of an example system for performing online incremental scaling of a compute cluster, in accordance with an embodiment.

FIG. 3 depicts a flowchart of a process for downscaling a subset of a compute cluster, in accordance with an embodiment.

FIG. 4 depicts a flowchart of a process for online incremental upscaling of a subset of a compute cluster, in accordance with an embodiment.

FIG. 5 depicts a flowchart of a process for determining a target size of a subset, in accordance with an embodiment.

FIG. 6 shows a state machine for performing online incremental scaling of a compute cluster, in accordance with an embodiment.

FIG. 7 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

As used herein, the term “subset” of a cluster is defined as one or more nodes of the cluster. In some instances, the subset of the cluster may be the same as the cluster and include every node of the cluster.

### II. Example Embodiments

Autoscaling is an aspect of workload management for obtaining additional compute capacity to meet higher demand (upscale) and release unused or underused capacity during periods of reduced activity to save operational costs (downscale). The primary goal of cluster autoscaling is to optimize resource allocation and minimize costs by scaling the cluster's capacity according to workload fluctuations. By dynamically adjusting the cluster size, cluster autoscaling enables efficient resource utilization, improved application performance, and cost savings. It allows organizations to automatically respond to varying workloads and ensure that the cluster is correctly sized without manual intervention

Cluster replication is a common auto scaling technique where a primary compute cluster accepts incoming queries until it has no more capacity, at which point, a new instance of the cluster is instantiated to process new queries. While this technique alleviates the resource pressure in the system, it is not cost effective. For example, if the primary cluster has 10 nodes and runs out of resources after accepting 100 queries, a new secondary cluster of 10 nodes is spun up for the 101st query. If there are no further incoming queries, the system ends up spinning an entire cluster just for a single query which could lead to massive resource wastage (until downscale kicks in) and increased costs.

In embodiments disclosed herein, a cluster of distributed compute nodes are employed to process multiple queries in a parallel manner. In embodiments, each query is represented by a directed acyclic graph (DAG) of operators (also referred to herein as “tasks”), referred herein as a “query graph.” Each task in a query graph is associated with a resource demand estimate. In embodiments, a query optimizer calculates the resource demand estimate for each type of resource. In embodiments, the resource demand estimate may be expressed as a d-dimensional demand vector, including a value for each type of resource. For example, a d-dimensional demand vector may include, but is not limited to, a 3-dimensional demand vector consisting of a CPU cost, a memory cost, and a disk or storage cost. In embodiments, the demand vector may include more or less dimensions representing more or less types of resources associated with the tasks. In embodiments, each task of the query graph is additionally associated with a concurrency requirement, such as, but not limited to, a degree of partitioned parallelism (DOPP) that represents the ideal number of nodes the task should be scheduled on to achieve optimal parallelism. Additionally, in embodiments, some tasks of the query graphs may have placement constraints; meaning they must be placed on specific compute nodes to utilize existing local data caches on those compute nodes. Such tasks may include, but are not limited to, scan operators, and may form the leaf vertices of the query graph.

In embodiments, a compute cluster includes one or more compute nodes having one or more types of resources to process one or more tasks. In embodiments, the resource capacity of a compute node may be represented by a d-dimensional capacity vector, including a value for each type of resource available on the compute node. For example, a d-dimensional capacity vector may include, but is not limited to, a 3-dimensional capacity vector consisting of a CPU capacity, a memory capacity, and a disk or storage capacity. In embodiments, the capacity vector may include more or less dimensions representing more or less types of resources associated with the compute nodes.

In embodiments, when a new incoming query arrives, the query graph associated with the query is added to a hypergraph, which may also be referred to herein as a workload graph. The hypergraph or workload graph is a collection of all tasks from all active queries, also referred to herein as the workload, with precedence or dependency constraints. In embodiments, tasks associated with a query are marked as complete as they complete execution, but remain in the hypergraph until the query completes execution. When the query completes execution, tasks associated with the query are removed from the hypergraph. In embodiments, tasks marked as complete may need to be re-run if their associated query were to restart. As such, the collection of tasks in the hypergraph may change over time through the addition of new query graphs associated with new queries and through the removal of tasks as their respective queries complete execution.

In embodiments, the hypergraph is recursively analyzed to determine the maximum workload demand of all tasks in the hypergraph that may execute concurrently. Due to precedence and/or dependency constraints, some tasks in the hypergraph may be blocked by other tasks and cannot execute concurrently with other tasks in the hypergraph. For example, a task may require input from another task and is blocked until the other task completes execution. To determine the maximum workload demand, in embodiments, a maximum workload demand is determined for tasks of the hypergraph that may execute concurrently. In embodiments, the maximum workload demand may be determined by recursively analyzing the hypergraph based on the precedence and/or dependency constraints to determine all possible scheduling sequences and the workload demand associated with the combination of tasks in each step in the scheduling sequences. In embodiments, the workload demand associated with each particular step in a scheduling sequence is determined by summing the d-dimensional demand vectors associated with the tasks of the particular step. For example, the d-dimensional vector may include, but is not limited to, a 3-dimensional demand vector consisting of a total CPU demand of tasks that may execute concurrently, a total memory demand of tasks that may execute concurrently, and a total disk demand of tasks that may execute concurrently. In embodiments, the combination of tasks having the highest workload demand may be selected as the worst case scenario, and the maximum workload demand is determined to be the workload demand associated with this combination of tasks. In embodiments, the cluster, or a subset thereof, may be immediately upscaled to the determined maximum workload demand. In embodiments, the maximum workload demand represents the resource demand that maximizes parallelism for the workload and/or satisfies other concurrency requirements. In other words, if a cluster is granted the amount of resources specified by the maximum workload demand, no unblocked task needs to wait for resources.

In embodiments, analysis of the hypergraph may be performed in a dynamic manner to scale the cluster, or a subset thereof, in finer increments. For instance, the maximum workload demand may be determined by summing the d-dimensional demand vectors associated with the tasks of the hypergraph that are unblocked (i.e., is not blocked by another task). In embodiments, when a task completes execution and/or is marked as complete, the d-dimensional demand vector associated with the task may be subtracted from the maximum workload demand. Additionally, when a particular task completes execution and/or is marked as complete, the d-dimensional demand vector(s) associated with blocked tasks, if any, may be added to the maximum workload demand. Furthermore, when a task is re-run, the d-dimensional demand vector associated with the task may be added to the maximum workload demand. This dynamic approach may, in embodiments, allow the cluster to closely match the workload demand. However, this approach also introduces additional overhead associated with a higher frequency of scaling.

In embodiments, an ideal cluster size may be determined based the demand vector of the workload and the resource capacity of each compute node. In embodiments, the number of compute nodes required to satisfy each resource type may be determined by dividing the total resource demand for each resource type by the compute node's resource capacity of the corresponding resource type. In embodiments, the (e.g., ideal) cluster size may be determined as the maximum of the number of compute nodes required to satisfy each of the resource types. In embodiments, the ideal cluster size may be calculated using equation 1 below, where D is a 3-dimensional vector representing the resource demand of the workload and X is a 3-dimensional vector representing the resource capacity of each compute node. In embodiments, the ideal cluster size may further consider the DOPP of each task. For instance, if a task in the hypergraph has a DOPP of 5, then the ideal cluster size would be at least 5.

In embodiments, the ideal cluster size is determined continuously, periodically, and/or in response to changes in the hypergraph. For instance, the ideal cluster size may be determined using a state machine that continuously monitors the resource demand in the system to assess if the system is under resource pressure or if it is overprovisioned. When the system is experiencing resource pressure, more compute nodes are requested via an upscale request to the management service. When the system has more capacity than needed, some of the capacity is released through a downscale request to the management service.

In embodiments, the ideal cluster size may be determined at an automatically, dynamically, and/or manually adjustable frequency.

$$Ideal cluster size = max ( \frac{D . CPU}{X . CPU} , \frac{D . Memory}{X . Memory} , \frac{D . Disk}{X . Disk} ) \qquad Equation 1$$

While the ideal cluster size represents the ideal number of compute nodes for the current state of the hypergraph, in embodiments, it may be undesirable to scale the cluster every time the ideal cluster size changes. In embodiments, autoscaling of a compute cluster may be performed according to a target cluster size that is determined based on one or more autoscaling policies. For example, upscaling and/or downscaling of the cluster may be performed according to the same or different autoscaling policies. Furthermore, in embodiments, subsets of the cluster may be scaled according to the same or different autoscaling policies.

In embodiments, one or more autoscaling policies may be employed to determine a target cluster size in various ways. For example, an autoscaling policy may calculate a target cluster size based on one or more historical values of the ideal cluster size. In embodiments, this may include, but is not limited to, calculating a target cluster size as a maximum, a moving maximum, a minimum, a moving minimum, an average, a moving average, a median, and/or a moving median of one or more historical values of the ideal cluster size. In embodiments, an autoscaling policy may predict a target cluster size by employing one or more heuristic and/or machine learning models that are generated based on one or more historical values of the ideal cluster size.

In embodiments, the number of values employed by the one or more autoscaling policies may be based on a configurable window. This may include, in embodiments, one or more of the most recent ideal cluster size values, a sampling of the historical ideal cluster size values, a subset of the historical ideal size values, and/or all of the historical ideal size values. Furthermore, in embodiments, the size of the configurable window may be automatically, dynamically, and/or manually updated based on various feedback, such as, but not limited to, collected metrics representing the actual utilization of the cluster, and/or human feedback. In embodiments, the target cluster size is determined continuously, periodically, and/or in response to changes in the ideal cluster size. Furthermore, in embodiments, the target cluster size may be determined at an automatically, dynamically, and/or manually adjustable frequency.

In embodiments, resource utilization during workload execution may be monitored to determine the accuracy of the calculated ideal cluster size and/or target cluster size. Based on the difference between the estimated resource demand and the actual resource utilization, in embodiments, the target cluster size is adjusted to account for this difference. For example, the target cluster size may be multiplied by a first factor (e.g., 70%) to reduce the magnitude of autoscaling, or a second factor (e.g., 120%) to increase the magnitude of autoscaling. In embodiments, the first and/or second factors may be adjusted based on a pressure tolerance. For example, a target cluster size for a workload with a high pressure tolerance will be multiplied by a smaller factor, resulting in less scaling. Similarly, a target cluster size for a workload with a low pressure tolerance will be multiplied by a higher factor, resulting in more scaling. However, a target cluster size for a workload with a low pressure tolerance will be multiplied by a higher factor, resulting in more scaling. In embodiments, the pressure tolerance and/or the multiplying factor may be automatically, dynamically, and/or manually adjusted by comparing the estimated resource demand to the actual resource utilization.

In an embodiment, autoscaling of a cluster may be performed by, for example, comparing the current size of the cluster with the target size of the cluster. For example, when the current size of the cluster is less than the target cluster size, a request and/or command may be transmitted to a management service to upscale the cluster by adding one or more compute nodes to the cluster and/or a subset thereof. In embodiments, a single request and/or command may be transmitted to the management service to upscale a plurality of subsets of a cluster. For instance, a first and a second subset of a cluster may be upscaled by 2 and 3 nodes, respectively, by transmitting a single request and/or command to the management service to add 5 nodes to the cluster. In embodiments, compute nodes may be added one at a time, or a plurality at a time. For example, if the target cluster size is 5 and the current cluster size is 3, two nodes may be added using a single request and/or command. Adding multiple nodes at the same time may result in a reduction in overhead. For instance, when nodes are added one at a time to cluster that has a distributed cache, the distributed cache needs to be redistributed each time a node is added to a cluster. However, when a plurality of nodes are added at the same time to a cluster that has a distributed cache, the distributed cache only needs to be redistributed once, thus reducing overhead costs.

After upscaling, in embodiments, new tasks are scheduled on the cluster in a manner that takes advantage of the newly added node(s) of the cluster. For instance, new tasks may be scheduled on one or more nodes of the cluster, where the one or more nodes include the newly added node(s). In embodiments, the scheduling of tasks after an upscaling event may be performed using one or more scheduling policies. In embodiments, a single scheduling policy may be employed throughout the lifecycle of the cluster, for example, but not limited to, by scheduling new tasks on compute nodes with the lowest utilization. After an upscaling event, tasks may be scheduled on the newly added node(s) under such a scheduling policy because the newly added node(s) may have the lowest utilization. In an embodiment, one or more different scheduling policies may be employed for scheduling tasks after an upscaling event.

When the current size of the cluster is higher than the target cluster size, in embodiments, downscaling is initiated for the cluster. In embodiments, downscaling a cluster is performed gradually over time in order to gracefully remove compute nodes from a cluster without disrupting tasks executing on the compute nodes. For example, when downscaling is initiated, in embodiments, one or more compute nodes of the cluster are designated for downscaling or draining. In embodiments, compute node(s) may be designated in various ways, including, but not limited to, designating compute node(s) having the lowest utilization, the lowest number of executing tasks, and/or the earliest expected completion time of all tasks.

After a compute node is designated for downscaling or draining, in embodiments, no additional tasks are scheduled on these nodes. Instead, in embodiments, new tasks are only scheduled on compute nodes that have not been designated for downscaling or draining. When all tasks executing on a compute node designated for downscaling or draining complete execution, a request and/or command may be transmitted to a management service to remove the compute node from the cluster.

In embodiments, compute nodes of a cluster may be logically grouped into one or more subsets that are also referred to herein as cluster views. Cluster views are described in greater detail in U.S. patent application Ser. No. ______ (Attorney Docket No. 413295-US-NP), entitled “SPLIT CLUSTER FOR COMPUTE SCALE AND CACHE PRESERVATION,” filed on Sep. 26, 2023, and which claims priority to provisional U.S. Patent Application No. 63/503,664, entitled “SPLIT CLUSTER FOR COMPUTE SCALE AND CACHE PRESERVATION,” filed on May 22, 2023, the entireties of which are incorporated by reference herein. In one example, a first subset of compute nodes may be designated as a cache type cluster (locality view) and a second subset of compute nodes may be designated as a computation type cluster (utility view). In embodiments, a cluster view is a disjoint subset of nodes in a cluster. The locality and utility type views restrict access to specific sets of nodes to optimize (1) cache reuse or (2) elasticity, respectively. For instance, scan operators that benefit from local caching are scheduled in a locality view. Furthermore, computationally heavy tasks or operators are executed in the utility view. In embodiments, tasks may be scheduled on a particular cluster view based on one or more characteristics or properties associated with the task, including, but not limited to, type of task, type of resources associated with the task type, and/or estimated resource demands associated with the task type.

Autoscaling techniques described herein for autoscaling an entire cluster may also be applied to scale each cluster view of the cluster. In clusters comprising a plurality of cluster views, in embodiments, each cluster view may be independently autoscaled according to one or more autoscaling policies. For instance, in embodiments, autoscaling of a computation type cluster view may performed in finer increments and/or at a higher frequency in order to closely track the ideal size of the cluster view. In contrast, autoscaling of cache type cluster views may be performed with higher increments in order to reduce overhead costs associated with redistribution of the cache. Additionally, downscaling of cache type cluster views may be performed conservatively in order to ensure availability of the cached data. For example, downscaling a cache type cluster view too soon after a drop in demand may result in the need to upscale the cache type cluster view in the near future.

These and further embodiments are disclosed herein that enable the functionality described above and further such functionality. Such embodiments are described in further detail as follows.

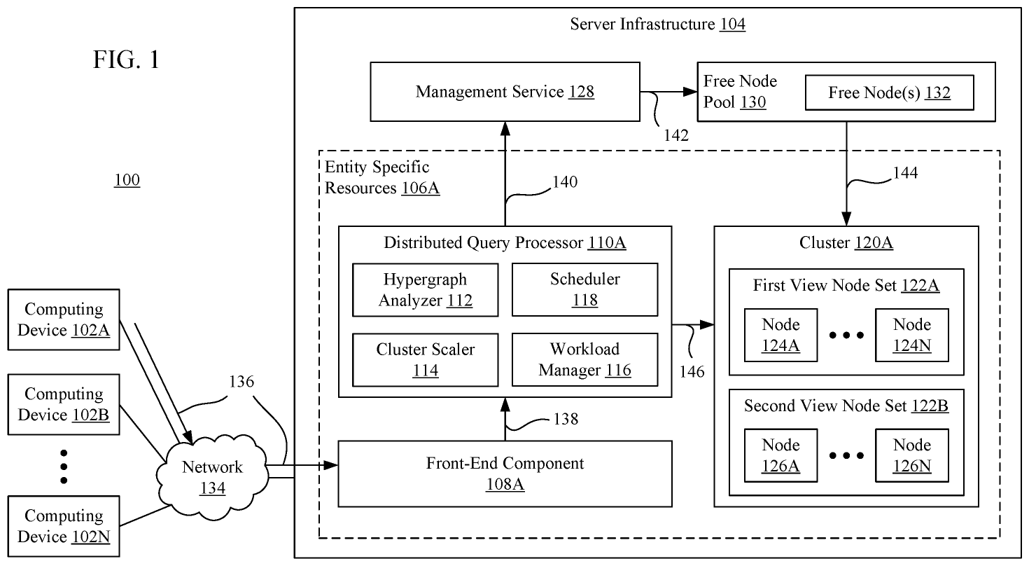

For instance, FIG. 1 shows a block diagram of an example system 100 for performing online incremental scaling of a compute cluster, in accordance with an embodiment. As shown in FIG. 1, system 100 includes one or more computing devices 102A, 102B, and 102N (collectively referred to as “computing devices 102A-102N”), and a server infrastructure 104 communicatively coupled to each other via network 134. Network 134 may comprise one or more networks such as local area networks (LANs), wide area networks (WANs), enterprise networks, the Internet, etc., and may include one or more wired and/or wireless portions. System 100 is described in further detail as follows.

Server infrastructure 104 may be a network-accessible server set (e.g., a cloud-based environment or platform). As shown in FIG. 1, server infrastructure includes a set of entity specific resources 106A, a management service 128, and a free node pool 130. In embodiments, entity specific resources 106A is associated with an entity, such as, but not limited to, a customer, a tenant, a company, a department, a group, a person, a user, and/or the like. Furthermore, while FIG. 1 depicts only one set of entity specific resource, in embodiments, server infrastructure 104 may include additional sets of entity specific resources for one or more entities (not depicted). Entity specific resources 106A includes a front-end component 108A, a distributed query processor 110A, and a cluster 120A, each of which are associated with the entity. Distributed query processor 110A further includes a hypergraph analyzer 112, a cluster scaler 114, a workload manager 116, and a scheduler 118. Cluster 120A is a compute cluster (or “computer cluster”) that includes multiple compute nodes (computing devices), and is configured to perform computational workloads by request. Cluster 120A may include one or more cluster views, such as, but not limited to, a first view node set 122A that comprises one or more nodes 124A-124N, and/or second view node set 122B that comprises one or more nodes 126A-126N. Free node pool 130 includes one or more free node(s) 132.

Front-end component 108A is configured to receive a query 136 from computing device(s) 102A-102N. Front-end component 108A may, in embodiments, process query 136 to generate a processed query 138, and provide processed query 138 to distributed query processor 110A. In embodiments, processed query 138 may include, but is not limited to, a query graph, an optimized query graph, a query plan, and/or an optimized query plan.

Distributed query processor 110A is configured to manage cluster 120A associated with entity specific resources 106A, including to monitor the utilization of cluster 120A, and/or view(s) 122 thereof, scale cluster 120A, and/or view(s) 122 thereof, schedule tasks on cluster 120A and/or view(s) 122 thereof. Management service 110A may be incorporated as a service executing on one or more computing devices of server infrastructure 104.

Hypergraph analyzer 112 is configured to recursively analyze the hypergraph to determine a maximum workload demand indicative of the maximum workload demand of all tasks in the hypergraph that may execute concurrently. As discussed above, due to precedence or dependency constraints, some tasks in the hypergraph may be blocked by other tasks and cannot execute concurrently with other tasks in the hypergraph. In embodiments, hypergraph analyzer 112 may determine the maximum workload demand by recursively analyzing the hypergraph based on the precedence and/or dependency constraints to determine all possible scheduling sequences and the workload demand associated with the combination of tasks in each step in the scheduling sequences. For instance, the combination of tasks having the highest workload demand may be selected as the worst case scenario, and the maximum workload demand is determined to be the workload demand associated with this combination of tasks. In embodiments, hypergraph analyzer 112 may further determine an ideal cluster size for cluster 120A, and/or cluster views therein, based on the maximum workload demand, the resource capacity of node(s) 124A-124N, and/or 126A-126N, and/or the DOPP associated with each task in the hypergraph.

Cluster scaler 114 is configured to autoscale cluster 120A and/or cluster views therein, based on one or more autoscaling policies. In embodiments, cluster scaler 114 may calculate a target cluster size based on one or more historical values of the ideal cluster size, including, but not limited to, by calculating a target cluster size as a maximum, a moving maximum, a minimum, a moving minimum, an average, a moving average, a median, and/or a moving median of one or more historical values of the ideal cluster size. In embodiments, cluster scaler 114 may predict a target cluster size by employing one or more heuristic and/or machine learning models that are generated based on one or more historical values of the ideal cluster size. When the size of a cluster or cluster view is less than the target size, in embodiments, cluster scaler 114 may perform upscaling of cluster 120A by transmitting a request 140 to management service 128 to add one or more free node(s) 132 to cluster 120A as node(s) 124A-124N, and/or 126A-126N. In embodiments, a single request 140 may be transmitted to management service 128 to upscale a plurality of subsets 204 of cluster 120A. For instance, cluster scaler 114 may upscale first view node set 122A by 2 nodes and second view node set 122B by 3 nodes by transmitting a single request 140 to management service 128 add 5 free nodes 132 from free node pool 130 to cluster 120A. In embodiments, cluster scaler 114 may allocate and/or assign the newly added free nodes 132 by updating subset(s) 204. When the size of a cluster or cluster view is greater than the target size, in embodiments, cluster scaler 114 may initiate downscaling of cluster 120A. As discussed above, cluster scaler 114 may designate one or more node(s) 124A-124N and/or 126A-126N of cluster 120A for downscaling or draining. After all tasks executing on node(s) 124A-124N and/or 126A-126N that have been designated for downscaling complete execution, in embodiments, cluster scaler 114 may transmit a request 140 to management service 128 to remove the drained node(s) from cluster 120A. In embodiments, node(s) designated for draining may become fully drained at different points in time depending on the size of tasks running on the node(s). As such, when all tasks executing on a compute node designated for downscaling or draining complete execution, a request and/or command may be transmitted to a management service to remove the compute node from the cluster without waiting for all node(s) designated for draining to complete draining. In embodiments, request 140 may cause management service 128 to return the removed node(s) to free node pool 130 as free node(s) 132.

Workload manager 116 is configured to receive processed query 138 front-end component 108A, and add query graph(s) associated with the processed query 138 to the hypergraph. In embodiments, workload manager 116 may also be configured to remove task(s) associated with processed query 138 from the hypergraph when the processed query 138 completes execution. Additionally, workload manager 116 may, in embodiments, mark each task in the hypergraph as complete as they complete execution.

Scheduler 118 is configured to schedule one or more tasks 146 on node(s) 124A-124N and/or 126A-126N for execution. In embodiments, scheduler 118 may consider resource requirements of task(s) 146, the DOPP associated with task(s) 146, the available resources of node(s) 124A-124N and/or 126A-126N, and/or various constraints to determine where to schedule task(s) 146 in order to optimize resource utilization and/or maintaining high availability. By continuously monitoring the cluster's state and workload demands, scheduler 118 may dynamically adapt to changes and ensure the optimal distribution of tasks across the available nodes, thereby enabling effective workload management and resource allocation.

In an embodiment, the nodes of cluster 120A may be co-located (e.g., housed in one or more nearby buildings with associated components such as backup power supplies, redundant data communications, environmental controls, etc.) to form a datacenter, or may be arranged in other manners. For example, in an embodiment, one or more nodes of cluster 120A may be located at a collection of datacenters in a distributive manner. In accordance with an embodiment, system 100 comprises part of the Microsoft® Azure® cloud computing platform, owned by Microsoft Corporation of Redmond, Washington, although this is only an example and not intended to be limiting.

Each of node(s) 124A-124N, and/or 126A-126N may comprise one or more server computers, server systems, and/or computing devices. Each of node(s) 124A-124N, and/or 126A-126N may be configured to execute one or more software applications (or “applications”) and/or services and/or manage hardware resources (e.g., processors, memory, etc.), which may be utilized by users (e.g., customers) of the network-accessible server set. Node(s) 124A-124N, and/or 126A-126N may also be configured for specific uses, including to execute virtual machines, machine learning workspaces, scale sets, databases, etc. In embodiments, node(s) 124A-124N may be configured identically, similarly, and/or differently than node(s) 126A-126N. Furthermore, node(s) 124A-124N, and/or 126A-126N may, in embodiments, receive task(s) 146 from distributed query processor 110A, and execute task(s) 146.

Management service 128 is configured to scale cluster 120A by adding or removing nodes 124A-124N, and/or 126A-126N. In embodiments, management service 128 may receive a request 140 from cluster scaler 114 to add nodes to cluster 120A, and/or remove nodes from cluster 120A. Responsive to request 140, in embodiments, management service 128 may associate or dissociate node(s) 124A-124N and/or 126A-126N with cluster 120A. For example, management service 128 may provide an instruction 142 to free node pool 130 to allocate one or more nodes 144 from free node(s) 132 to cluster 120A as node(s) 124A-124N and/or 126A-126N. Similarly, management service 128 may provide instruction 142 to free node pool 130 to reclaim one or more node(s) 124A-124N and/or 126A-126N from cluster 120A as free node(s) 132.

Computing devices 102A-102N may each be any type of stationary or mobile processing device, including, but not limited to, a desktop computer, a server, a mobile or handheld device (e.g., a tablet, a personal data assistant (PDA), a smart phone, a laptop, etc.), an Internet-of-Things (IoT) device, etc. Each of computing devices 102A-102N stores data and executes computer programs, applications, and/or services.

Users are enabled to utilize the applications and/or services (e.g., services executing on nodes 124A-124N, and 126A-126N, and/or an analytics service (not depicted)) offered by the network-accessible server set via computing devices 102A-102N. For example, a user may be enabled to utilize the applications and/or services offered by the network-accessible server set by signing-up with a cloud services subscription with a service provider of the network-accessible server set (e.g., a cloud service provider). Upon signing up, the user may be given access to a portal of server infrastructure 104, not shown in FIG. 1. A user may access the portal via computing devices 102A-102N (e.g., by a browser application executing thereon). For example, the user may use a browser executing on computing device 102A to traverse a network address (e.g., a uniform resource locator) to a portal of server infrastructure 104, which invokes a user interface (e.g., a web page) in a browser window rendered on computing device 102A. The user may be authenticated (e.g., by requiring the user to enter user credentials (e.g., a username, password, PIN, etc.)) before being given access to the portal.

Upon being authenticated, the user may utilize the portal to perform various cloud management-related operations. Such operations include, but are not limited to, accessing an analytics services to monitor deployed applications and/or services, submitting queries (e.g., SQL queries) to databases of server infrastructure 104; etc.

Examples of compute resources include, but are not limited to, virtual machines, virtual machine scale sets, clusters, ML workspaces, serverless functions, storage disks (e.g., maintained by storage node(s) of server infrastructure 104), web applications, database servers, data objects (e.g., data file(s), table(s), structured data, unstructured data, etc.) stored via the database servers, etc. The portal may be configured in any manner, including being configured with any combination of text entry, for example, via a command line interface (CLI), one or more graphical user interface (GUI) controls, etc., to enable user interaction.

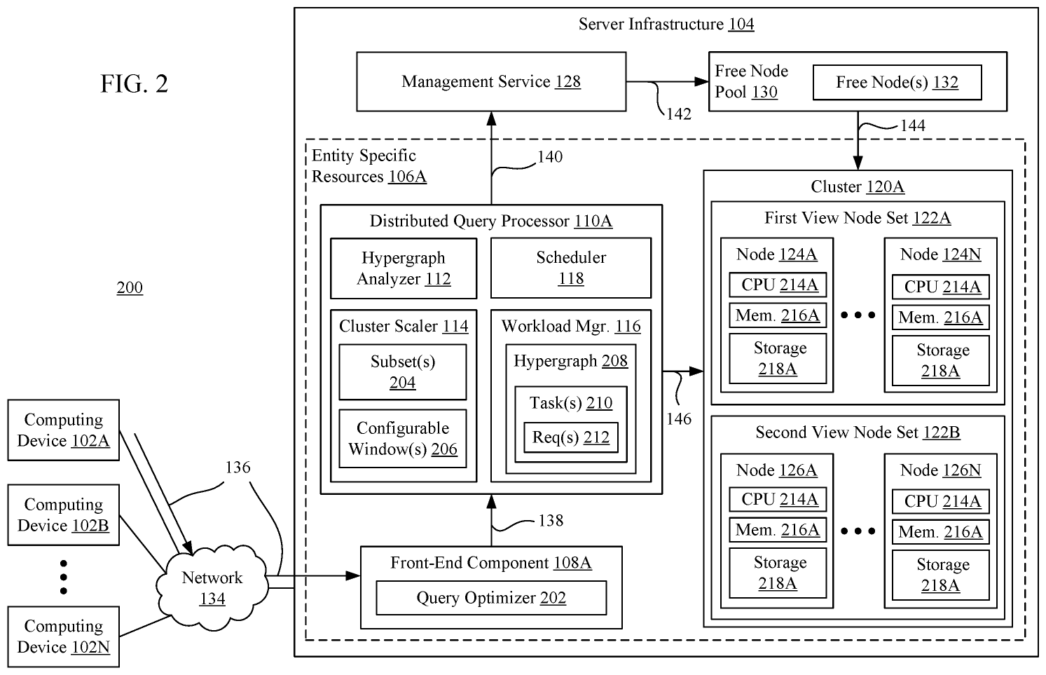

Embodiments described herein may operate in various ways to incrementally scale a cluster. For instance, FIG. 2 shows a block diagram of an example system 200 for performing online incremental scaling of a compute cluster, in accordance with an embodiment. As shown in FIG. 2, system 200 includes computing device(s) 102, server infrastructure 104, entity specific resources 106A, front-end component 108A, distributed query processor 110A, hypergraph analyzer 112, cluster scaler 114, workload manager 116, scheduler 118, cluster 120A, first view node set 122A, second view node set 122B, node(s) 124A-124N, node(s) 126A-126N, management service 128, free node pool 130, free node(s) 132, as shown FIG. 1. In system 200, node(s) 124A-124N and node(s) 126A-126N further include one or more computing resources (CPU) 214A-214N, one or more memory resources 216A-216N, and one or more storage resources 218A-218N. Furthermore, front-end component 108A further includes a query optimizer 202. Additionally, cluster scaler 114 further includes one or more cluster subsets 204 and one or more configurable windows 206. Additionally, workload manager 116 further includes a hypergraph 208 that further includes one or more tasks 210 (operators of user queries) associated with one or more requirements 212. System 200 is described in further detail as follows.

CPU(s) 214, memory(s) 216, and/or storage(s) 218 are resources of compute cluster 120A that may be allocated to execute task(s) 210. In embodiments, the amount of resources associated with CPU(s) 214, memory(s) 216, and/or storage(s) 218 may be the same or may be different between each of node(s) 124A-124N and/or node(s) 126A-126N. In embodiments, the amount of resources associated with node(s) 124A-124N and/or node(s) 126A-126N may be the same or may be different than free node(s) 132 in free node pool 130.

Query optimizer 202 is configured to receive query 136 from computing device(s) 102A-102N, and optimizes query 136 to generate processed query 138. In embodiments, processed query 138 may include, but is not limited to, a query graph and/or a query plan associated with an optimized query corresponding to query 138. Query optimizer 202 is configured to provide processed query 138 for scheduling on cluster 120A, and/or cluster views therein.

Subset(s) 204 indicate which node(s) 124A-124N and/or node(s) 126A-126N on cluster 120A that are allocated to each subset or cluster view of cluster(s) 120. In embodiments, subset(s) 204 are logical mappings that associate node(s) 124A-124N and/or node(s) 126A-126N with first view node set 122A, and/or second view node set 122B, respectively. For example, subset(s) 204 may correspond to first view node set 122A, and/or second view node set 122B, and first view node set 122A, and/or second view node set 122B may be referred to herein as subset(s) 204. In embodiments, cluster scaler 114 may update subset(s) 204 when nodes are added and/or removed from cluster 120A, and/or cluster views therein. In embodiments, some, or all subsets of subset(s) 204 may be associated with configurable window(s) 206.

Configurable window(s) 206 indicate a time frame for determining a target cluster or sub-cluster size. In embodiments, configurable window(s) 206 may indicate the number of values (e.g., last 10 cluster size values) or a period of time (e.g., most recent 10 minutes) to use in calculating the target cluster or sub-cluster size. In embodiments, configurable window(s) 206 may be automatically, dynamically, and/or manually updated based on various feedback, such as, but not limited to, collected metrics representing the actual utilization of cluster 120A, and/or human feedback.

Hypergraph 208 is a collection of all task(s) 210 from all active queries with precedence or dependency constraints. In embodiments, tasks associated with a query are marked as complete as they complete execution, but remain in the hypergraph in case the tasks need to be re-run. When the query completes execution, tasks associated with the query are removed from the hypergraph. As such, the collection of tasks in the hypergraph may change over time through the addition of new query graphs associated with new queries and through the removal of tasks as their respective queries complete execution.

Task(s) 210 may be associated with requirement(s) 212, such as, but not limited to precedence or dependency constraints, placement constraints, resource requirements, and/or concurrency requirements (e.g., DOPP).

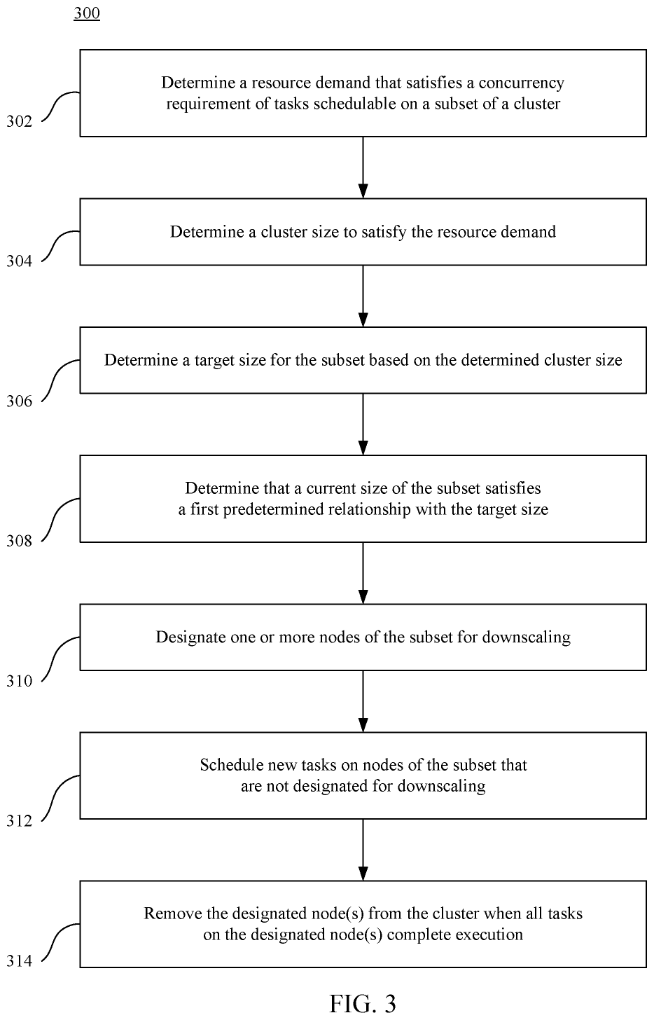

Embodiments described herein may operate in various ways to autoscale a cluster. For instance, FIG. 3 depicts a flowchart 300 of a process for autoscaling a cluster, in accordance with an embodiment. Server infrastructure 104, distributed query processor 110A, hypergraph analyzer 112, cluster scaler 114, management service 128, and/or free node pool 130 of FIGS. 1 and 2 may operate according to flowchart 300, for example. Note that not all steps of flowchart 300 may need to be performed in all embodiments, and in some embodiments, the steps of flowchart 300 may be performed in different orders than shown. Flowchart 300 is described as follows with respect to FIGS. 1 and 2 for illustrative purposes.

Flowchart 300 starts at step 302. In step 302, a resource demand that satisfies a concurrency requirement of tasks schedulable on a subset of a cluster is determined. For example, hypergraph analyzer 112 may analyze the hypergraph to determine a resource demand that satisfies a first concurrency requirement for tasks schedulable on subset(s) 204 of cluster 120A. As discussed above, hypergraph analyzer 112 may determine the maximum workload demand of all tasks in the hypergraph that may execute concurrently by summing the resource demand estimates for combinations of tasks that may execute concurrently.

In step 304, a cluster size to satisfy the resource demand is determined. For example, hypergraph analyzer 112 and/or cluster scaler 114 may determine the ideal size for a particular subset 204 of cluster 120A based on the resource demand that satisfies the first concurrency requirement for tasks schedulable on the particular subset 204 and the resource capacity of node(s) 124A-124N, and/or 126A-126N. In embodiments, hypergraph analyzer 112 and/or cluster scaler 114 may determine the number of compute nodes required to satisfy each resource type by dividing the total resource demand for each resource type by the compute node's resource capacity of the corresponding resource type. In embodiments, hypergraph analyzer 112 and/or cluster scaler 114 may determine the ideal cluster size of the particular subset 204 as the maximum of the number of compute nodes required to satisfy each of the resource types. In embodiments, hypergraph analyzer 112 and/or cluster scaler 114 may further consider the DOPP of each task when determining the ideal size of the particular subset 204.

In step 306, a target size for the subset may be determined based on the ideal size. For example, cluster scaler 114 may determine a target size for the particular subset 204 of cluster 120A based on the ideal size of the particular subset 204. As discussed above, cluster scaler 114 may employ one or more autoscaling policies to determine a target cluster size. For example, an autoscaling policy may calculate a target cluster size based on one or more historical values of the ideal cluster size. In embodiments, this may include, but is not limited to, calculating a target cluster size as a maximum, a moving maximum, a minimum, a moving minimum, an average, a moving average, a median, and/or a moving median of one or more historical values of the ideal cluster size. In embodiments, an autoscaling policy may predict a target cluster size by employing one or more heuristic and/or machine learning models that are generated based on one or more historical values of the ideal cluster size. In embodiments, the number of values employed by the one or more autoscaling policies may be based on a particular configurable window(s) 206. This may include, in embodiments, one or more of the most recent ideal cluster size values, a sampling of the historical ideal cluster size values, a subset of the historical ideal size values, and/or all of the historical ideal size values. Configurable window(s) 206 control the aggressiveness of downscaling. For instance, a window covering a smaller time frame will result in more aggressive downscaling based on a shorter time window, while a window covering a larger time frame will result in less aggressive downscaling based on a longer time window. Furthermore, in embodiments, the size of the configurable window(s) 206 may be automatically, dynamically, and/or manually updated based on various feedback, such as, but not limited to, collected metrics representing the actual utilization of the cluster, and/or human feedback. In embodiments, the target cluster size is determined continuously, periodically, and/or in response to changes in the ideal cluster size. Furthermore, in embodiments, the target cluster size may be determined at an automatically, dynamically, and/or manually adjustable frequency.

In step 308, a current size of the subset is determined to satisfy a first predetermined relationship with the target size for the subset. For example, cluster scaler 114 may determine that the number of node(s) 124A-124N, and/or 126A-126N in cluster 120A allocated to the particular subset 204 satisfies a first predetermined relationship (e.g., greater than) with the target size for the particular subset 204. In other embodiments, the current size of the subset may be determine to satisfy a different predetermined relationship with the target size (e.g., the number of nodes allocated to the particular subset 204 is less than the target size, etc.).

In step 310, at least one node of the subset is designated for downscaling. For example, cluster scaler 114 may designate node(s) 124A-124N, and/or 126A-126N in cluster 120A for downscaling or draining. As discussed above, in embodiments, cluster scaler 114 may designate node(s) 124A-124N, and/or 126A-126N based on the node(s) 124A-124N, and/or 126A-126N having the lowest utilization, the lowest number of executing tasks, and/or the earliest expected completion time of all tasks.

In step 312, new tasks are scheduled on nodes of the subset that are not designated for downscaling. For example, scheduler 118 may schedule new tasks on node(s) 124A-124N and/or 126A-126N that have not been designated for downscaling or draining.

In step 314, designated node(s) are removed from the cluster when all tasks on the designated node(s) complete execution. For example, when all tasks on node(s) 124A-124N and/or 126A-126N that have been designated for downscaling or draining complete execution, cluster scaler 114 may transmit a request 140 to management service 128 to remove the node(s) from cluster 120A. In embodiments, node(s) designated for draining may become fully drained at different points in time depending on the size of tasks running on the node(s). As such, when all tasks executing on a compute node designated for downscaling or draining complete execution, a request and/or command may be transmitted to a management service to remove the compute node from the cluster without waiting for all node(s) designated for draining to complete draining. In embodiments, management service 128 returns the removed node(s) to free pool 130 as a free node(s) 132.

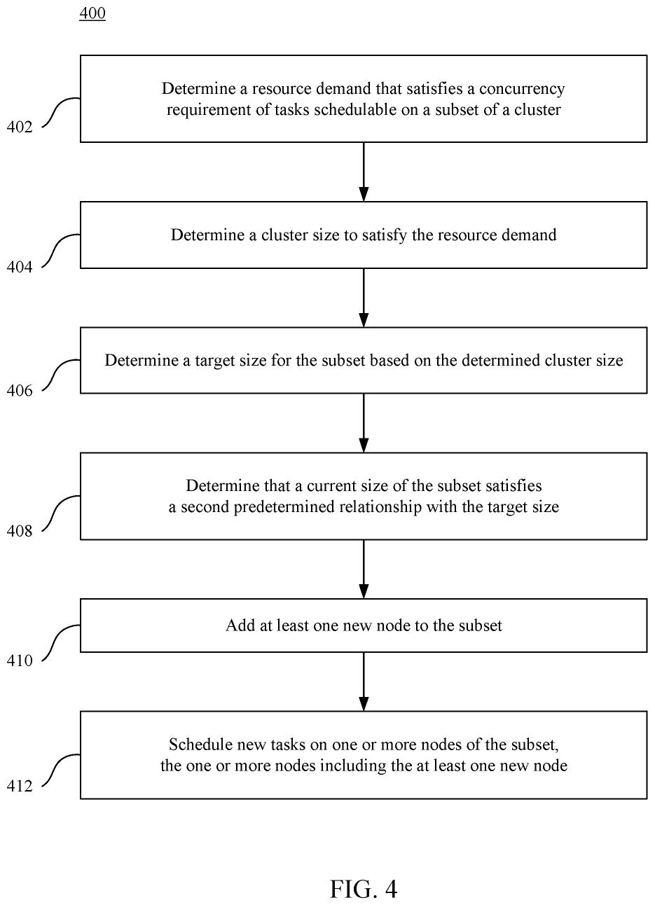

Embodiments described herein may operate in various ways to scale up a cluster. For instance, FIG. 4 depicts a flowchart 400 of a process for online incremental upscaling of a subset of a compute cluster, in accordance with an embodiment. Server infrastructure 104, distributed query processor 110A, hypergraph analyzer 112, cluster scaler 114, management service 128, and/or free node pool 130 of FIGS. 1 and 2 may operate according to flowchart 400, for example. Note that not all steps of flowchart 400 may need to be performed in all embodiments, and in some embodiments, the steps of flowchart 400 may be performed in different orders than shown. Flowchart 400 is described as follows with respect to FIGS. 1 and 2 for illustrative purposes.

Flowchart 400 starts at step 402. In step 402, a resource demand that satisfies a concurrency requirement of tasks schedulable on a subset of a cluster is determined. For example, hypergraph analyzer 112 may analyze the hypergraph to determine a resource demand that satisfies a first concurrency requirement for tasks schedulable on subset(s) 204 of cluster 120A. As discussed above, hypergraph analyzer 112 may determine the maximum workload demand of all tasks in the hypergraph that may execute concurrently by summing the resource demand estimates for combinations of tasks that may execute concurrently.

In step 404, a cluster size to satisfy the resource demand is determined. For example, hypergraph analyzer 112 and/or cluster scaler 114 may determine the ideal size for a particular subset 204 of cluster 120A based on the resource demand that satisfies the first concurrency requirement for tasks schedulable on the particular subset and the resource capacity of node(s) 124A-124N, and/or 126A-126N. In embodiments, hypergraph analyzer 112 and/or cluster scaler 114 may determine the number of compute nodes required to satisfy each resource type by dividing the total resource demand for each resource type by the compute node's resource capacity of the corresponding resource type. In embodiments, hypergraph analyzer 112 and/or cluster scaler 114 may determine the ideal cluster size of the particular subset 204 as the maximum of the number of compute nodes required to satisfy each of the resource types. In embodiments, hypergraph analyzer 112 and/or cluster scaler 114 may further consider the DOPP of each task when determining the ideal size of the particular subset 204.

In step 406, a target size for the subset may be determined based on the ideal size. For example, cluster scaler 114 may determine a target size for the particular subset 204 of cluster 120A based on the ideal size of the particular subset 204. As discussed above, cluster scaler 114 may employ one or more autoscaling policies to determine a target cluster size. For example, an autoscaling policy may calculate a target cluster size based on one or more historical values of the ideal cluster size. In embodiments, this may include, but is not limited to, calculating a target cluster size as a maximum, a moving maximum, a minimum, a moving minimum, an average, a moving average, a median, and/or a moving median of one or more historical values of the ideal cluster size. In embodiments, an autoscaling policy may predict a target cluster size by employing one or more heuristic and/or machine learning models that are generated based on one or more historical values of the ideal cluster size. In embodiments, the number of values employed by the one or more autoscaling policies may be based on a configurable window(s) 206. This may include, in embodiments, one or more of the most recent ideal cluster size values, a sampling of the historical ideal cluster size values, a subset of the historical ideal size values, and/or all of the historical ideal size values. In embodiments, the size of the configurable window(s) 206 may be automatically, dynamically, and/or manually updated based on various feedback, such as, but not limited to, collected metrics representing the actual utilization of cluster 120A, and/or human feedback. In embodiments, the target cluster size is determined continuously, periodically, and/or in response to changes in the ideal cluster size. Furthermore, in embodiments, the target cluster size may be determined at an automatically, dynamically, and/or manually adjustable frequency.

In step 408, a current size of the subset is determined to satisfy a second predetermined relationship with the target size for the subset. For example, cluster scaler 114 may determine that the number of node(s) 124A-124N, and/or 126A-126N in cluster 120A allocated to the particular subset 204 is less than the target size for the particular subset 204.

In step 410, at least one new node is added to the subset. For example, cluster scaler 114 may transmit request 140 to management service 128 to cause free node(s) 132 to be added from free node pool 130 to the particular subset 204 of cluster 120A. In embodiments, a single request 140 may be transmitted to management service 128 to upscale a plurality of subsets 204 of cluster 120A. For instance, cluster scaler 114 may upscale first view node set 122A by 2 nodes and second view node set 122B by 3 nodes by transmitting a single request 140 to management service 128 add 5 free nodes 132 from free node pool 130 to cluster 120A. In embodiments, cluster scaler 114 may allocate and/or assign the newly added free nodes 132 by updating subset(s) 204.

In step 412, new tasks are scheduled on one or more nodes of the subset, the one or more nodes including the at least one new node. For example, scheduler 118 may schedule new tasks on a set of node(s) of cluster 120A that include the newly added node(s) 132.

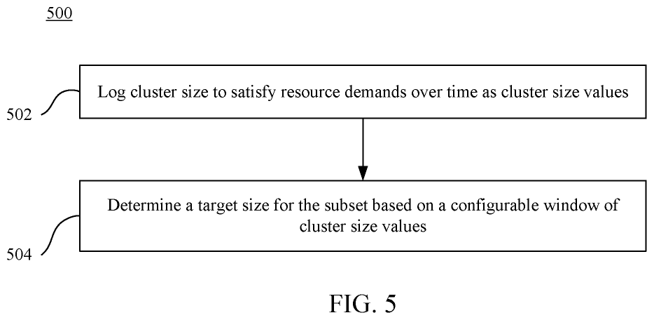

Embodiments described herein may operate in various ways to determine a target size for a subset of a cluster. For instance, FIG. 5 depicts a flowchart 500 of a process for determining a target size of a cluster, in accordance with an embodiment. Server infrastructure 104, management service 128, distributed query processor 110A, cluster scaler 114 and/or scheduler 118 of FIGS. 1 and 2 may operate according to flowchart 500, for example. Note that not all steps of flowchart 500 may need to be performed in all embodiments, and in some embodiments, the steps of flowchart 400 may be performed in different orders than shown. Flowchart 500 is described as follows with respect to FIGS. 1 and 2 for illustrative purposes.

Flowchart 500 starts at step 502. In step 502, cluster size to satisfy resource demands are logged over time as cluster size values. For example, cluster scaler 114 may log the cluster size needed to satisfy resource demands over time as cluster size values.

In step 504, a target size for the subset may be determined based on a configurable window of cluster size values. For example, cluster scaler 114 may determine a target size for a particular subset 204 based on a configurable window(s) 206 of cluster size values. As discussed above, in embodiments, the target size may be determined as a mathematical function (e.g., mean, median, maximum, etc.) of a configurable window 206 of cluster size values. In embodiments, the target size may be determined using a heuristic model, and/or a machine-learning model that is generated based on the cluster size values.

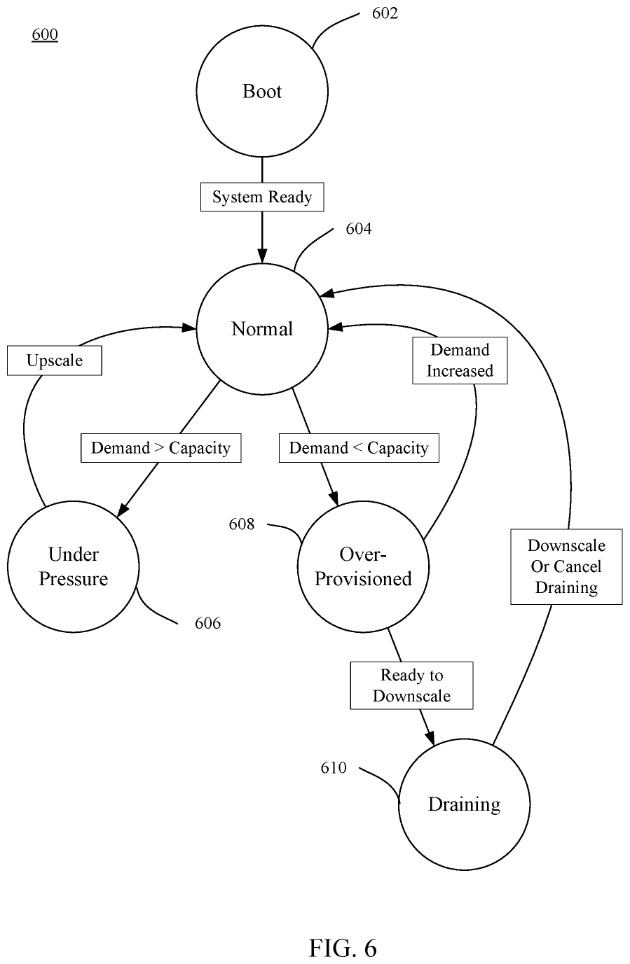

Embodiments described herein may operate in various ways to autoscale a cluster. For instance, FIG. 6 depicts a state machine 600 for online incremental scaling of a compute cluster, in accordance with an embodiment. Server infrastructure 104, distributed query processor 110A, hypergraph analyzer 112, cluster scaler 114, management service 128, and/or free node pool 130 of FIGS. 1 and 2 may operate according to state machine 600, for example. State machine 600 is described as follows with respect to FIGS. 1 and 2 for illustrative purposes.

As shown in FIG. 6, state machine 600 starts at a “Boot” state 602. In “Boot” state 602, distributed query processor 110A initializes and discovers the current state of cluster 120A. After distributed query processor 110A is ready, state machine 600 transitions to a “Normal” state 604.

At “Normal” state 604, state machine 600 monitors the demand on the compute cluster to determine whether the scaling is necessary. In “Normal” state 604, the compute cluster operates with a capacity that roughly equals the demand. When the demand exceeds the capacity of the compute cluster, state machine 600 transitions from “Normal” state 604 to an “Under Pressure” state 606. For example, state machine 600 may transition to “Under Pressure” state 606 when the number of node(s) 124A-124N, and/or 126A-126N in cluster 120A allocated to the particular subset 204 is less than the target size for the particular subset 204. When the demand is less than the capacity of the compute cluster, state machine 600 transitions from “Normal” state 604 to an “Over-Provisioned” state 608. For example, state machine 600 may transition to “Over-Provisioned” state 608 when the number of node(s) 124A-124N, and/or 126A-126N in cluster 120A allocated to the particular subset 204 satisfies the first predetermined relationship with the target size for the particular subset 204.

At “Under Pressure” state 606, state machine 600 issues an upscale request to scale the compute cluster. For instance, state machine 600 may transmit request 140 to management service 128 to cause node(s) 132 to be added from free node pool 130 to cluster 120A. After issuing the upscale request, state machine 600 returns to “Normal” state 604.

At “Over-Provisioned” state 608, state machine 600 compares the target size determined by configurable window 206 (as described in conjunction FIG. 5 above) to the current target size, and, when the target size determined by configurable window 206 is less than the current target size, state machine 600 designates one or more nodes of the compute cluster for downscaling. For example, state machine 600 may designate node(s) 124A-124N, and/or 126A-126N in cluster 120A for downscaling or draining. As discussed above, in embodiments, node(s) 124A-124N, and/or 126A-126N may be designated for downscaling based on having the lowest utilization, the lowest number of executing tasks, and/or the earliest expected completion time of all tasks. Once node(s) are designated for downscaling, state machine 600 transitions to a “Draining” state 610.

Additionally, at “Over-Provisioned” state 608, state machine 600 may continue to monitor the demand on the compute cluster to determine whether the compute cluster is still over-provisioned. If state machine 600 determines that the demand has increased and the compute cluster is no longer over-provisioned, state machine 600 may transition back to “Normal” state 602.

At “Draining” state 610, state machine 600 allows tasks executing on the node(s) designated for downscaling to complete execution. During “Draining” state 610, no new tasks are scheduled on the node(s) designated for downscaling and the node(s) are allowed to “drain.” After all tasks executing on the node(s) designated for downscaling complete execution, state machine 600 issues a downscale request to remove the drained node(s) from the compute cluster. In embodiments, node(s) designated for draining may become fully drained at different points in time depending on the size of tasks running on the node(s). As such, when all tasks executing on a compute node designated for downscaling or draining complete execution, a request and/or command may be transmitted to a management service to remove the compute node from the cluster without waiting for all node(s) designated for draining to complete draining. For instance, state machine 600 may transmit request 140 to management service 128 to remove the node(s) from cluster 120A. In embodiments, management service 128 returns the removed node(s) to free pool 130 as a free node(s) 132. State machine 600 transitions back to “Normal” state 602 when all node(s) designated for draining have been removed from the compute cluster via downscale request(s), or when draining is cancelled due to an increase in demand on the compute cluster.

### III. Example Mobile Device and Computer System Implementation

The systems and methods described above in reference to FIGS. 1-6, including computing device(s) 102, server infrastructure 104, entity-specific resource(s) 106A, front-end component(s) 108A, distributed query processor 110A, hypergraph analyzer 112, cluster scaler 114, workload manager 116, scheduler 118, cluster 120A, first view node set 122A, second view node set 122B, node(s) 124, node(s) 126, management service 128, free node pool 130, nodes 132, network 134, query optimizer 202, subset(s) 204, configurable window(s) 206, hypergraph 208, task(s) 210, requirement(s) 212, CPU(s) 214A, memory(s) 216A, storage(s) 218A, state machine 600, and/or each of the components described therein, and the steps of flowcharts 300, 400 and/or 500 may be implemented in hardware, or hardware combined with one or both of software and/or firmware. For example, computing device(s) 102, server infrastructure 104, entity-specific resource(s) 106A, front-end component(s) 108A, distributed query processor 110A, hypergraph analyzer 112, cluster scaler 114, workload manager 116, scheduler 118, cluster 120A, first view node set 122A, second view node set 122B, node(s) 124, node(s) 126, management service 128, free node pool 130, nodes 132, network 134, query optimizer 202, subset(s) 204, configurable window(s) 206, hypergraph 208, task(s) 210, requirement(s) 212, CPU(s) 214A, memory(s) 216A, storage(s) 218A, state machine 600, and/or each of the components described therein, and the steps of flowcharts 300, 400 and/or 500 may be each implemented as computer program code/instructions configured to be executed in one or more processors and stored in a computer readable storage medium. Alternatively, computing device(s) 102, server infrastructure 104, entity-specific resource(s) 106A, front-end component(s) 108A, distributed query processor 110A, hypergraph analyzer 112, cluster scaler 114, workload manager 116, scheduler 118, cluster 120A, first view node set 122A, second view node set 122B, node(s) 124, node(s) 126, management service 128, free node pool 130, nodes 132, network 134, query optimizer 202, subset(s) 204, configurable window(s) 206, hypergraph 208, task(s) 210, requirement(s) 212, CPU(s) 214A, memory(s) 216A, storage(s) 218A, state machine 600, and/or each of the components described therein, and the steps of flowcharts 300, 400 and/or 500 may be each implemented in one or more SoCs (system on chip). An SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

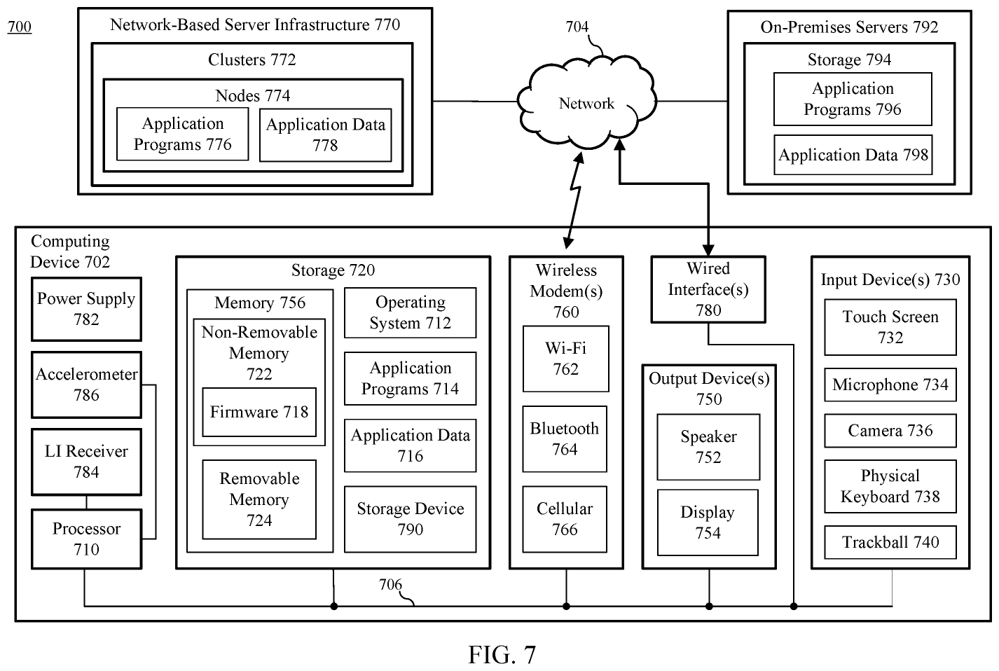

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 7. FIG. 7 shows a block diagram of an exemplary computing environment 700 that includes a computing device 702. In some embodiments, computing device 702 is communicatively coupled with devices (not shown in FIG. 7) external to computing environment 700 via network 704. Network 704 comprises one or more networks such as local area networks (LANs), wide area networks (WANs), enterprise networks, the Internet, etc., and may include one or more wired and/or wireless portions. Network 704 may additionally or alternatively include a cellular network for cellular communications. Computing device 702 is described in detail as follows.

Computing device 702 can be any of a variety of types of computing devices. For example, computing device 702 may be a mobile computing device such as a handheld computer (e.g., a personal digital assistant (PDA)), a laptop computer, a tablet computer (such as an Apple iPad™), a hybrid device, a notebook computer (e.g., a Google Chromebook™ by Google LLC), a netbook, a mobile phone (e.g., a cell phone, a smart phone such as an Apple® iPhone® by Apple Inc., a phone implementing the Google® Android™ operating system, etc.), a wearable computing device (e.g., a head-mounted augmented reality and/or virtual reality device including smart glasses such as Google® Glass™, Oculus Quest 2® by Reality Labs, a division of Meta Platforms, Inc, etc.), or other type of mobile computing device. Computing device 702 may alternatively be a stationary computing device such as a desktop computer, a personal computer (PC), a stationary server device, a minicomputer, a mainframe, a supercomputer, etc.

As shown in FIG. 7, computing device 702 includes a variety of hardware and software components, including a processor 710, a storage 720, one or more input devices 730, one or more output devices 750, one or more wireless modems 760, one or more wired interfaces 780, a power supply 782, a location information (LI) receiver 784, and an accelerometer 786. Storage 720 includes memory 756, which includes non-removable memory 722 and removable memory 724, and a storage device 790. Storage 720 also stores an operating system 712, application programs 714, and application data 716. Wireless modem(s) 760 include a Wi-Fi modem 762, a Bluetooth modem 764, and a cellular modem 766. Output device(s) 750 includes a speaker 752 and a display 754. Input device(s) 730 includes a touch screen 732, a microphone 734, a camera 736, a physical keyboard 738, and a trackball 740. Not all components of computing device 702 shown in FIG. 7 are present in all embodiments, additional components not shown may be present, and any combination of the components may be present in a particular embodiment. These components of computing device 702 are described as follows.

A single processor 710 (e.g., central processing unit (CPU), microcontroller, a microprocessor, signal processor, ASIC (application specific integrated circuit), and/or other physical hardware processor circuit) or multiple processors 710 may be present in computing device 702 for performing such tasks as program execution, signal coding, data processing, input/output processing, power control, and/or other functions. Processor 710 may be a single-core or multi-core processor, and each processor core may be single-threaded or multithreaded (to provide multiple threads of execution concurrently). Processor 710 is configured to execute program code stored in a computer readable medium, such as program code of operating system 712 and application programs 714 stored in storage 720. Operating system 712 controls the allocation and usage of the components of computing device 702 and provides support for one or more application programs 714 (also referred to as “applications” or “apps”). Application programs 714 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein.

Any component in computing device 702 can communicate with any other component according to function, although not all connections are shown for case of illustration. For instance, as shown in FIG. 7, bus 706 is a multiple signal line communication medium (e.g., conductive traces in silicon, metal traces along a motherboard, wires, etc.) that may be present to communicatively couple processor 710 to various other components of computing device 702, although in other embodiments, an alternative bus, further buses, and/or one or more individual signal lines may be present to communicatively couple components. Bus 706 represents one or more of any of several types of bus structures, including a memory bus or memory controller, a peripheral bus, an accelerated graphics port, and a processor or local bus using any of a variety of bus architectures.

Storage 720 is physical storage that includes one or both of memory 756 and storage device 790, which store operating system 712, application programs 714, and application data 716 according to any distribution. Non-removable memory 722 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 722 may include main memory and may be separate from or fabricated in a same integrated circuit as processor 710. As shown in FIG. 7, non-removable memory 722 stores firmware 718, which may be present to provide low-level control of hardware. Examples of firmware 718 include BIOS (Basic Input/Output System, such as on personal computers) and boot firmware (e.g., on smart phones). Removable memory 724 may be inserted into a receptacle of or otherwise coupled to computing device 702 and can be removed by a user from computing device 702. Removable memory 724 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 790 may be present that are internal and/or external to a housing of computing device 702 and may or may not be removable. Examples of storage device 790 include a hard disk drive, a SSD, a thumb drive (e.g., a USB (Universal Serial Bus) flash drive), or other physical storage device.

One or more programs may be stored in storage 720. Such programs include operating system 712, one or more application programs 714, and other program modules and program data. Examples of such application programs may include, for example, computer program logic (e.g., computer program code/instructions) for implementing one or more of computing device(s) 102, server infrastructure 104, entity-specific resource(s) 106A, front-end component(s) 108A, distributed query processor 110A, hypergraph analyzer 112, cluster scaler 114, workload manager 116, scheduler 118, cluster 120A, first view node set 122A, second view node set 122B, node(s) 124, node(s) 126, management service 128, free node pool 130, nodes 132, network 134, query optimizer 202, subset(s) 204, configurable window(s) 206, hypergraph 208, task(s) 210, requirement(s) 212, CPU(s) 214A, memory(s) 216A, storage(s) 218A, state machine 600, and/or each of the components thereof, as well as the flowcharts/flow diagrams (e.g., flowcharts 300, 400 and/or 500) described herein, including portions thereof, and/or further examples described herein.

Storage 720 also stores data used and/or generated by operating system 712 and application programs 714 as application data 716. Examples of application data 716 include web pages, text, images, tables, sound files, video data, and other data, which may also be sent to and/or received from one or more network servers or other devices via one or more wired or wireless networks. Storage 720 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 702 through one or more input devices 730 and may receive information from computing device 702 through one or more output devices 750. Input device(s) 730 may include one or more of touch screen 732, microphone 734, camera 736, physical keyboard 738 and/or trackball 740 and output device(s) 750 may include one or more of speaker 752 and display 754. Each of input device(s) 730 and output device(s) 750 may be integral to computing device 702 (e.g., built into a housing of computing device 702) or external to computing device 702 (e.g., communicatively coupled wired or wirelessly to computing device 702 via wired interface(s) 780 and/or wireless modem(s) 760). Further input devices 730 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 754 may display information, as well as operating as touch screen 732 by receiving user commands and/or other information (e.g., by touch, finger gestures, virtual keyboard, etc.) as a user interface. Any number of each type of input device(s) 730 and output device(s) 750 may be present, including multiple microphones 734, multiple cameras 736, multiple speakers 752, and/or multiple displays 754.

One or more wireless modems 760 can be coupled to antenna(s) (not shown) of computing device 702 and can support two-way communications between processor 710 and devices external to computing device 702 through network 704, as would be understood to persons skilled in the relevant art(s). Wireless modem 760 is shown generically and can include a cellular modem 766 for communicating with one or more cellular networks, such as a GSM network for data and voice communications within a single cellular network, between cellular networks, or between the mobile device and a public switched telephone network (PSTN). Wireless modem 760 may also or alternatively include other radio-based modem types, such as a Bluetooth modem 764 (also referred to as a “Bluetooth device”) and/or Wi-Fi 762 modem (also referred to as an “wireless adaptor”). Wi-Fi modem 762 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 764 is configured to communicate with another Bluetooth-capable device according to the Bluetooth short-range wireless technology standard(s) such as IEEE 802.15.1 and/or managed by the Bluetooth Special Interest Group (SIG).

Computing device 702 can further include power supply 782, LI receiver 784, accelerometer 786, and/or one or more wired interfaces 780. Example wired interfaces 780 include a USB port, IEEE 1394 (Fire Wire) port, a RS-232 port, an HDMI (High-Definition Multimedia Interface) port (e.g., for connection to an external display), a DisplayPort port (e.g., for connection to an external display), an audio port, an Ethernet port, and/or an Apple® Lightning® port, the purposes and functions of each of which are well known to persons skilled in the relevant art(s). Wired interface(s) 780 of computing device 702 provide for wired connections between computing device 702 and network 704, or between computing device 702 and one or more devices/peripherals when such devices/peripherals are external to computing device 702 (e.g., a pointing device, display 754, speaker 752, camera 736, physical keyboard 738, etc.). Power supply 782 is configured to supply power to each of the components of computing device 702 and may receive power from a battery internal to computing device 702, and/or from a power cord plugged into a power port of computing device 702 (e.g., a USB port, an A/C power port). LI receiver 784 may be used for location determination of computing device 702 and may include a satellite navigation receiver such as a Global Positioning System (GPS) receiver or may include other type of location determiner configured to determine location of computing device 702 based on received information (e.g., using cell tower triangulation, etc.). Accelerometer 786 may be present to determine an orientation of computing device 702.

Note that the illustrated components of computing device 702 are not required or all-inclusive, and fewer or greater numbers of components may be present as would be recognized by one skilled in the art. For example, computing device 702 may also include one or more of a gyroscope, barometer, proximity sensor, ambient light sensor, digital compass, etc. Processor 710 and memory 756 may be co-located in a same semiconductor device package, such as being included together in an integrated circuit chip, FPGA, or system-on-chip (SOC), optionally along with further components of computing device 702.

In embodiments, computing device 702 is configured to implement any of the above-described features of flowcharts herein. Computer program logic for performing any of the operations, steps, and/or functions described herein may be stored in storage 720 and executed by processor 710.

In some embodiments, server infrastructure 770 may be present in computing environment 700 and may be communicatively coupled with computing device 702 via network 704. Server infrastructure 770, when present, may be a network-accessible server set (e.g., a cloud-based environment or platform). As shown in FIG. 7, server infrastructure 770 includes clusters 772. Each of clusters 772 may comprise a group of one or more compute nodes and/or a group of one or more storage nodes. For example, as shown in FIG. 7, cluster 772 includes nodes 774. Each of nodes 774 are accessible via network 704 (e.g., in a “cloud-based” embodiment) to build, deploy, and manage applications and services. Any of nodes 774 may be a storage node that comprises a plurality of physical storage disks, SSDs, and/or other physical storage devices that are accessible via network 704 and are configured to store data associated with the applications and services managed by nodes 774. For example, as shown in FIG. 7, nodes 774 may store application data 778.

Each of nodes 774 may, as a compute node, comprise one or more server computers, server systems, and/or computing devices. For instance, a node 774 may include one or more of the components of computing device 702 disclosed herein. Each of nodes 774 may be configured to execute one or more software applications (or “applications”) and/or services and/or manage hardware resources (e.g., processors, memory, etc.), which may be utilized by users (e.g., customers) of the network-accessible server set. For example, as shown in FIG. 7, nodes 774 may operate application programs 776. In an implementation, a node of nodes 774 may operate or comprise one or more virtual machines, with each virtual machine emulating a system architecture (e.g., an operating system), in an isolated manner, upon which applications such as application programs 776 may be executed.

In an embodiment, one or more of clusters 772 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 772 may be a datacenter in a distributed collection of datacenters. In embodiments, exemplary computing environment 700 comprises part of a cloud-based platform such as Amazon Web Services® of Amazon Web Services, Inc. or Google Cloud Platform™ of Google LLC, although these are only examples and are not intended to be limiting.

In an embodiment, computing device 702 may access application programs 776 for execution in any manner, such as by a client application and/or a browser at computing device 702. Example browsers include Microsoft Edge® by Microsoft Corp. of Redmond, Washington, Mozilla Firefox®, by Mozilla Corp. of Mountain View, California, Safari®, by Apple Inc. of Cupertino, California, and Google® Chrome by Google LLC of Mountain View, California.

For purposes of network (e.g., cloud) backup and data security, computing device 702 may additionally and/or alternatively synchronize copies of application programs 714 and/or application data 716 to be stored at network-based server infrastructure 770 as application programs 776 and/or application data 778. For instance, operating system 712 and/or application programs 714 may include a file hosting service client, such as Microsoft® OneDrive® by Microsoft Corporation, Amazon Simple Storage Service (Amazon S3)® by Amazon Web Services, Inc., Dropbox® by Dropbox, Inc., Google Drive™ by Google LLC, etc., configured to synchronize applications and/or data stored in storage 720 at network-based server infrastructure 770.

In some embodiments, on-premises servers 792 may be present in computing environment 700 and may be communicatively coupled with computing device 702 via network 704. On-premises servers 792, when present, are hosted within an organization's infrastructure and, in many cases, physically onsite of a facility of that organization. On-premises servers 792 are controlled, administered, and maintained by IT (Information Technology) personnel of the organization or an IT partner to the organization. Application data 798 may be shared by on-premises servers 792 between computing devices of the organization, including computing device 702 (when part of an organization) through a local network of the organization, and/or through further networks accessible to the organization (including the Internet). Furthermore, on-premises servers 792 may serve applications such as application programs 796 to the computing devices of the organization, including computing device 702. Accordingly, on-premises servers 792 may include storage 794 (which includes one or more physical storage devices such as storage disks and/or SSDs) for storage of application programs 796 and application data 798 and may include one or more processors for execution of application programs 796. Still further, computing device 702 may be configured to synchronize copies of application programs 714 and/or application data 716 for backup storage at on-premises servers 792 as application programs 796 and/or application data 798.

Embodiments described herein may be implemented in one or more of computing device 702, network-based server infrastructure 770, and on-premises servers 792. For example, in some embodiments, computing device 702 may be used to implement systems, clients, or devices, or components/subcomponents thereof, disclosed elsewhere herein. In other embodiments, a combination of computing device 702, network-based server infrastructure 770, and/or on-premises servers 792 may be used to implement the systems, clients, or devices, or components/subcomponents thereof, disclosed elsewhere herein.

As used herein, the terms “computer program medium,” “computer-readable medium,” and “computer-readable storage medium,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 720. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 714) may be stored in storage 720. Such computer programs may also be received via wired interface(s) 780 and/or wireless modem(s) 760 over network 704. Such computer programs, when executed or loaded by an application, enable computing device 702 to implement features of embodiments discussed herein. Accordingly, such computer programs represent controllers of the computing device 702.

Embodiments are also directed to computer program products comprising computer code or instructions stored on any computer-readable medium or computer-readable storage medium. Such computer program products include the physical storage of storage 720 as well as further physical storage types.

### IV. Additional Example Embodiments

In an embodiment, a method for scaling a cluster includes: determining, by analyzing a workload graph, a first resource demand that satisfies a first concurrency requirement of first tasks schedulable on a first subset of the cluster; determining a first cluster size to satisfy the first resource demand; determining a first target size for the first subset based on the first cluster size; determining that a current size of the first subset satisfies a first predetermined relationship with the first target size; designating a first node of the first subset for downscaling; scheduling new first tasks on nodes of the first subset that are not designated for downscaling; and removing the designated first node from the cluster subsequent to all tasks on the designated first node completing execution.

In an embodiment, the method further includes: determining that the current size of the first subset does not satisfy the first predetermined relationship with the first target size; and adding a new node to the first subset.

In an embodiment, the method further includes: determining, by analyzing the workload graph, second tasks schedulable on a second subset of the cluster, wherein the first tasks comprise tasks associated with a placement constraint; determining, by analyzing the workload graph, a second resource demand that satisfies a second concurrency requirement of the second tasks; determining a second cluster size to satisfy the second resource demand; determining a second target size for the second subset based on the second cluster size; determining that a current size of the second subset satisfies a second predetermined relationship with the second target size; designating a second node of the second subset for downscaling; scheduling new second tasks on nodes of the second subset that are not designated for downscaling; and removing the designated second node from the cluster subsequent to all tasks on the designated second node completing execution.

In an embodiment, the method further includes: logging the first cluster size over time as a plurality of first cluster size values; and logging the second cluster size over time as a plurality of second cluster size values, wherein said determining a first target size is based on a first configurable window of first cluster size values and said determining the second target size is based on a second configurable window of second cluster size values that covers a different timeframe than the first configurable window.

In an embodiment, determining, by analyzing a workload graph, a first resource demand that satisfies a first concurrency requirement of first tasks schedulable on a first subset of the cluster comprises: recursively analyzing the workload graph to determine scheduling sequences of the first tasks based on precedence and/or dependency constraints associated with the first tasks, each scheduling sequence comprising one or more scheduling steps; determining, for each particular scheduling step, a corresponding resource demand for a subset of first tasks schedulable during the particular scheduling step based on the concurrency requirements of the subset of first tasks; determining the scheduling step having a highest corresponding resource demand; and determining the highest corresponding resource demand as the first resource demand.

In an embodiment, determining, by analyzing the workload graph, the first resource demand that satisfies the first concurrency requirement of the first tasks comprises: determining, by analyzing task dependency information in the workload graph, first tasks that may execute concurrently; and determining the first resource demand as a summation of concurrency requirements associated with the first tasks that may execute concurrently.

In an embodiment, designating a first node of the first subset for downscaling comprises at least one of: designating, for downscaling, a node of the first subset having a lowest resource utilization; or designating, for downscaling, a node of the first subset having an earliest expected completion time, wherein the expected completion time is the expected time for all tasks executing on the node to complete execution.

In an embodiment, the first subset comprises all nodes of the cluster.

In an embodiment, a system for scaling a cluster includes: a processor; a memory device that stores program code structured to cause the processor to: determine, by analyzing a workload graph, a first resource demand that satisfies a first concurrency requirement of first tasks schedulable on a first subset of the cluster; determine a first cluster size to satisfy the determined first resource demand; determine a first target size for the first subset based on the determined first cluster size; determine that a current size of the first subset satisfies a first predetermined relationship with the first target size; designate a first node of the first subset for downscaling; schedule new first tasks on nodes of the first subset that are not designated for downscaling; and remove the designated first node from the cluster subsequent to all tasks on the designated first node completing execution.

In an embodiment, the program code is further structured to cause the processor to: determine, by analyzing the workload graph, second tasks schedulable on a second subset of the cluster, wherein the first tasks comprise tasks associated with a placement constraint; determine, by analyzing the workload graph, a second resource demand that satisfies a second concurrency requirement of the second tasks; determine a second cluster size to satisfy the second resource demand; determine a second target size for the second subset based on the second cluster size; determine that a current size of the second subset satisfies a second predetermined relationship with the second target size; designate a second node of the second subset for downscaling; schedule new tasks on nodes of the second subset that are not designated for downscaling; and remove the designated second node from the cluster subsequent to all tasks on the designated second node completing execution.

In an embodiment, the program code is further structured to cause the processor to: log the first cluster size over time as a plurality of first cluster size values; and log the second cluster size over time as a plurality of second cluster size values; wherein said determine the first target size is based on a first configurable window of first cluster size values and said determine the second target size is based on a second configurable window of second cluster size values that covers a different timeframe than the first configurable window.

In an embodiment, to designate the first node of the first subset for downscaling, the program code is further structured to cause the processor to perform at least one of: designate, for downscaling, a node of the first subset having a lowest resource utilization; or designate, for downscaling, a node of the first subset having an earliest expected completion time, wherein the expected completion time is the expected time for all tasks executing on the node to complete execution.

In an embodiment, to determine, by analyzing the workload graph, the first resource demand that satisfies a first concurrency requirement of first tasks, the program code is further structured to cause the processor to: determine, by analyzing task dependency information in the workload graph, first tasks that may execute concurrently; and determine the first resource demand as a summation of concurrency requirements associated with the first task that may execute concurrently.

In an embodiment, the first subset comprises all nodes of the cluster.

In an embodiment, a computer-readable storage medium comprising computer-executable instructions, that when executed by a processor, cause the processor to: determine, by analyzing a workload graph, a first resource demand that satisfies a first concurrency requirement of first tasks schedulable on a first subset of the cluster; determine a first cluster size to satisfy the first resource demand; determine a first target size for the first subset based on the first cluster size; determine that a current size of the first subset satisfies a first predetermined relationship with the first target size; designate a first node of the first subset for downscaling; schedule new first tasks on nodes of the first subset that are not designated for downscaling; and remove the designated first node from the cluster subsequent to all tasks on the designated first node completing execution.

In an embodiment, the computer-executable instructions, when executed by the processor, further cause the processor to: determine, by analyzing the workload graph, second tasks schedulable on a second subset of the cluster, wherein the first tasks comprise tasks associated with a placement constraint; determine, by analyzing the workload graph, a second resource demand that satisfies a second concurrency requirement of the second tasks; determine a second cluster size to satisfy the determined second resource demand; determine a second target size for the second subset based on the determined second cluster size; determine that the current size of the second subset satisfies a second predetermined relationship with the second target size; designate a second node of the second subset for downscaling; schedule new tasks on nodes of the second subset that are not designated for downscaling; and remove the designated second node from the cluster subsequent to all tasks on the designated second node completing execution.

In an embodiment, the computer-executable instructions, when executed by the processor, further cause the processor to: log the first cluster size over time as a plurality of first cluster size values, wherein said determine the first target size is based on one or more of: a configurable window of first cluster size values; a heuristic model based on the first cluster size values; or a machine learning model trained on the first cluster size values.

In an embodiment, to designate the first node of the first subset for downscaling, the computer-executable instructions, when executed by the processor, further cause the processor to: designate, for downscaling, a node of the first subset having a lowest resource utilization; or designate, for downscaling, a node of the first subset having an earliest expected completion time, wherein the expected completion time is the expected time for all tasks executing on the node to complete execution.

In an embodiment, to determine, by analyzing the workload graph, the first resource demand that satisfies the first concurrency requirement of first tasks, the computer-executable instructions, when executed by the processor, further cause the processor to: determine, by analyzing task dependency information in the workload graph, first tasks that may execute concurrently; and determine the first resource demand as a summation of concurrency requirements associated with the first tasks that may execute concurrently. In an embodiment, the first subset comprises all nodes of the cluster.

### V. Conclusion

References in the specification to “one embodiment.” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Furthermore, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

While various embodiments of the present disclosure have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed:

1. A method for scaling a cluster, comprising:
determining, by analyzing a workload graph, a first resource demand that satisfies a first concurrency requirement of first tasks schedulable on a first subset of the cluster;
determining a first cluster size to satisfy the first resource demand;
determining a first target size for the first subset based on the first cluster size;
determining that a current size of the first subset satisfies a first predetermined relationship with the first target size;
designating a first node of the first subset for downscaling;
scheduling new first tasks on nodes of the first subset that are not designated for downscaling; and
removing the designated first node from the cluster subsequent to all tasks on the designated first node completing execution.

2. The method of claim 1, further comprising:
determining that the current size of the first subset does not satisfy the first predetermined relationship with the first target size; and
adding a new node to the first subset.

3. The method of claim 1, further comprising:
determining, by analyzing the workload graph, second tasks schedulable on a second subset of the cluster, wherein the first tasks comprise tasks associated with a placement constraint;
determining, by analyzing the workload graph, a second resource demand that satisfies a second concurrency requirement of the second tasks;
determining a second cluster size to satisfy the second resource demand;
determining a second target size for the second subset based on the second cluster size;
determining that a current size of the second subset satisfies a second predetermined relationship with the second target size;
designating a second node of the second subset for downscaling;
scheduling new second tasks on nodes of the second subset that are not designated for downscaling; and
removing the designated second node from the cluster subsequent to all tasks on the designated second node completing execution.

4. The method of claim 3, further comprising:
logging the first cluster size over time as a plurality of first cluster size values; and
logging the second cluster size over time as a plurality of second cluster size values,
wherein said determining a first target size is based on a first configurable window of first cluster size values and said determining the second target size is based on a second configurable window of second cluster size values that covers a different timeframe than the first configurable window.

5. The method of claim 1, wherein said determining, by analyzing a workload graph, a first resource demand that satisfies a first concurrency requirement of first tasks schedulable on a first subset of the cluster comprises:
recursively analyzing the workload graph to determine scheduling sequences of the first tasks based on precedence and/or dependency constraints associated with the first tasks, each scheduling sequence comprising one or more scheduling steps;
determining, for each particular scheduling step, a corresponding resource demand for a subset of first tasks schedulable during the particular scheduling step based on the concurrency requirements of the subset of first tasks;
determining the scheduling step having a highest corresponding resource demand; and
determining the highest corresponding resource demand as the first resource demand.

6. The method of claim 1, wherein said determining, by analyzing the workload graph, the first resource demand that satisfies the first concurrency requirement of the first tasks comprises:
determining, by analyzing task dependency information in the workload graph, first tasks that may execute concurrently; and
determining the first resource demand as a summation of concurrency requirements associated with the first tasks that may execute concurrently.

7. The method of claim 1, wherein said designating a first node of the first subset for downscaling comprises at least one of:
designating, for downscaling, a node of the first subset having a lowest resource utilization; or
designating, for downscaling, a node of the first subset having an earliest expected completion time, wherein the expected completion time is the expected time for all tasks executing on the node to complete execution.

8. The method of claim 1, wherein the first subset comprises all nodes of the cluster.

9. A system for scaling a cluster, comprising:
a processor;
a memory device that stores program code structured to cause the processor to:
determine, by analyzing a workload graph, a first resource demand that satisfies a first concurrency requirement of first tasks schedulable on a first subset of the cluster;
determine a first cluster size to satisfy the determined first resource demand;
determine a first target size for the first subset based on the determined first cluster size;
determine that a current size of the first subset satisfies a first predetermined relationship with the first target size;
designate a first node of the first subset for downscaling;
schedule new first tasks on nodes of the first subset that are not designated for downscaling; and
remove the designated first node from the cluster subsequent to all tasks on the designated first node completing execution.

10. The system of claim 9, wherein the program code is further structured to cause the processor to:
determine, by analyzing the workload graph, second tasks schedulable on a second subset of the cluster, wherein the first tasks comprise tasks associated with a placement constraint;
determine, by analyzing the workload graph, a second resource demand that satisfies a second concurrency requirement of the second tasks;
determine a second cluster size to satisfy the second resource demand;
determine a second target size for the second subset based on the second cluster size;
determine that a current size of the second subset satisfies a second predetermined relationship with the second target size;
designate a second node of the second subset for downscaling;
schedule new tasks on nodes of the second subset that are not designated for downscaling; and
remove the designated second node from the cluster subsequent to all tasks on the designated second node completing execution.

11. The system of claim 10, wherein the program code is further structured to cause the processor to:
log the first cluster size over time as a plurality of first cluster size values; and
log the second cluster size over time as a plurality of second cluster size values;
wherein said determine the first target size is based on a first configurable window of first cluster size values and said determine the second target size is based on a second configurable window of second cluster size values that covers a different timeframe than the first configurable window.

12. The system of claim 9, wherein, to designate the first node of the first subset for downscaling, the program code is further structured to cause the processor to perform at least one of:
designate, for downscaling, a node of the first subset having a lowest resource utilization; or
designate, for downscaling, a node of the first subset having an earliest expected completion time, wherein the expected completion time is the expected time for all tasks executing on the node to complete execution.

13. The system of claim 9, wherein, to determine, by analyzing the workload graph, the first resource demand that satisfies a first concurrency requirement of first tasks, the program code is further structured to cause the processor to:
determine, by analyzing task dependency information in the workload graph, first tasks that may execute concurrently; and
determine the first resource demand as a summation of concurrency requirements associated with the first task that may execute concurrently.

14. The system of claim 9, wherein the first subset comprises all nodes of the cluster.

15. A computer-readable storage medium comprising computer-executable instructions, that when executed by a processor, cause the processor to:
determine, by analyzing a workload graph, a first resource demand that satisfies a first concurrency requirement of first tasks schedulable on a first subset of the cluster;
determine a first cluster size to satisfy the first resource demand;
determine a first target size for the first subset based on the first cluster size;
determine that a current size of the first subset satisfies a first predetermined relationship with the first target size;
designate a first node of the first subset for downscaling;
schedule new first tasks on nodes of the first subset that are not designated for downscaling; and
remove the designated first node from the cluster subsequent to all tasks on the designated first node completing execution.

16. The computer-readable storage medium of claim 15, wherein the computer-executable instructions, when executed by the processor, further cause the processor to:
determine, by analyzing the workload graph, second tasks schedulable on a second subset of the cluster, wherein the first tasks comprise tasks associated with a placement constraint;
determine, by analyzing the workload graph, a second resource demand that satisfies a second concurrency requirement of the second tasks;
determine a second cluster size to satisfy the determined second resource demand;
determine a second target size for the second subset based on the determined second cluster size;
determine that the current size of the second subset satisfies a second predetermined relationship with the second target size;
designate a second node of the second subset for downscaling;
schedule new tasks on nodes of the second subset that are not designated for downscaling; and
remove the designated second node from the cluster subsequent to all tasks on the designated second node completing execution.

17. The computer-readable storage medium of claim 16, wherein the computer-executable instructions, when executed by the processor, further cause the processor to:
log the first cluster size over time as a plurality of first cluster size values,
wherein said determine the first target size is based on one or more of:
a configurable window of first cluster size values;
a heuristic model based on the first cluster size values; or
a machine learning model trained on the first cluster size values.

18. The computer-readable medium of claim 15, wherein, to designate the first node of the first subset for downscaling, the computer-executable instructions, when executed by the processor, further cause the processor to:
designate, for downscaling, a node of the first subset having a lowest resource utilization; or
designate, for downscaling, a node of the first subset having an earliest expected completion time, wherein the expected completion time is the expected time for all tasks executing on the node to complete execution.

19. The computer-readable medium of claim 15, wherein, to determine, by analyzing the workload graph, the first resource demand that satisfies the first concurrency requirement of first tasks, the computer-executable instructions, when executed by the processor, further cause the processor to:
determine, by analyzing task dependency information in the workload graph, first tasks that may execute concurrently; and
determine the first resource demand as a summation of concurrency requirements associated with the first tasks that may execute concurrently.

20. The computer-readable medium of claim 15, wherein the first subset comprises all nodes of the cluster.
